(19) United States
(12) Patent Application Publication
(10) Pub. No.: US 2005/0269342 A1
(43) Pub. Date: Dec. 8, 2005

(54) Dispenser support for liquid aseptic collectors

(76) Inventors: Celso Renato Junqueira Franco, Sao Paulo (BR); Ricardo Junqueira Franco, Säo Paulo (BR)

Correspondence Address: WILLIAM COLLARD;COLLARD & ROE, P.C., 1077 NORTHERN BOULEVARD, ROSLYN, NY, 11576, US

(21) Appl. No.: 10/523,868

(22) PCT Filed: May 8, 2003
(86) PCT No.: PCT/BR03/00063

§ 371 Date: Feb. 7, 2005

(30) Foreign Application Priority Data
Aug. 7, 2002 (BR) PI 020.3147-7

(51) Int. Cl. G07F 11/66

(52) U.S. Cl. 221/25

(57) ABSTRACT

Dispenser support for liquid aseptic collectors, comprising a base (1) with bearings (2), which inferior extremities can be craved in the platform (1), as well as the top of the called bearings are equally shaped (3a-3b), to support the liquid aseptic collector (6) roll (5) tube (4) or to support an equally rotatory shaft (7) that goes freely through the roll (5) tube (4) interior, whose roll unrolls forward passing through the frontal guide (9), formed by a U flatboat bar (10) with a fluctuant counterweight cylinder (11), through which goes the collectors (6) attached to each other with perforated lines (12), and finally the whole set is protected by a cast (13) that not only includes a lateral transparent window (14), but also has an window exit (15), through where the device is reloaded.

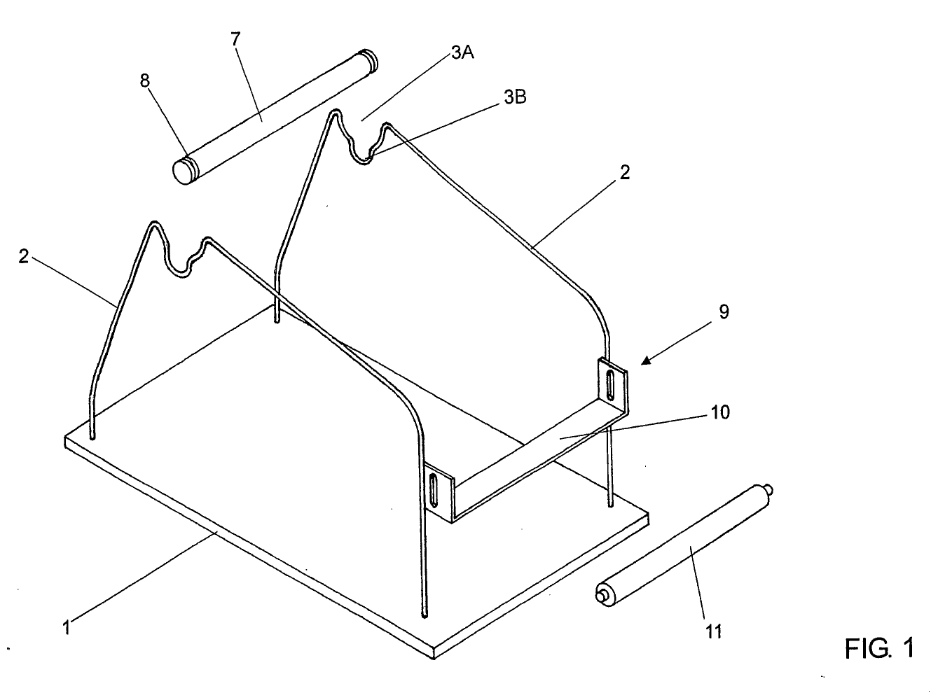

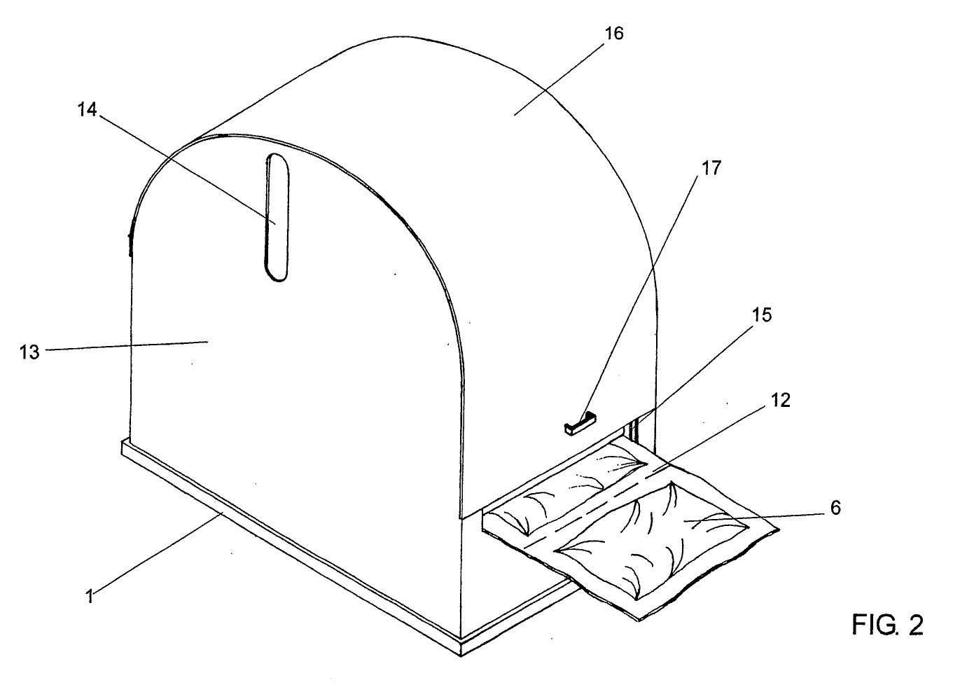

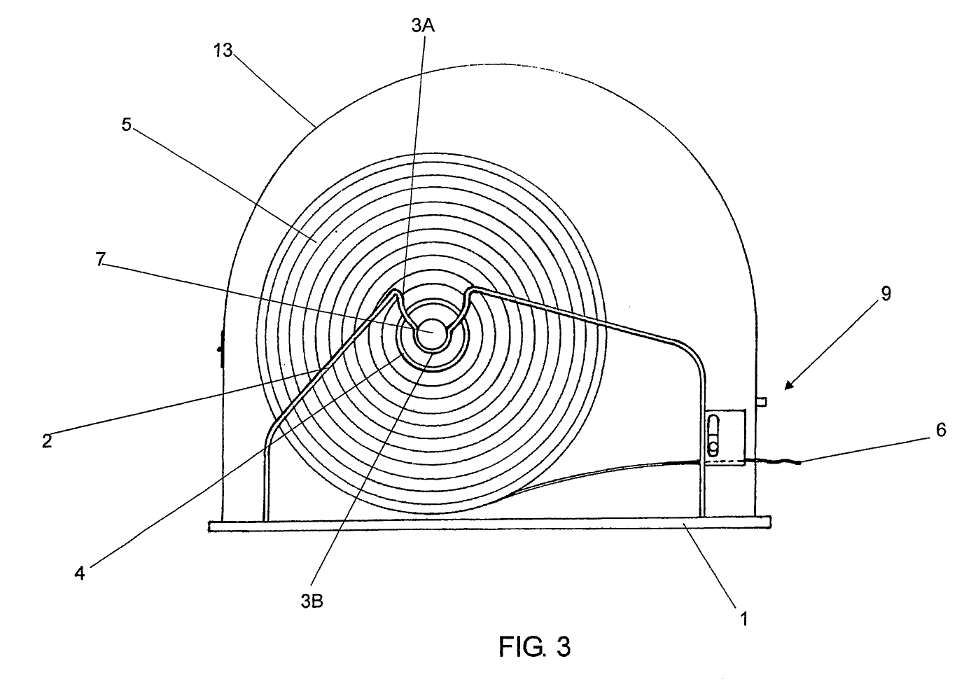

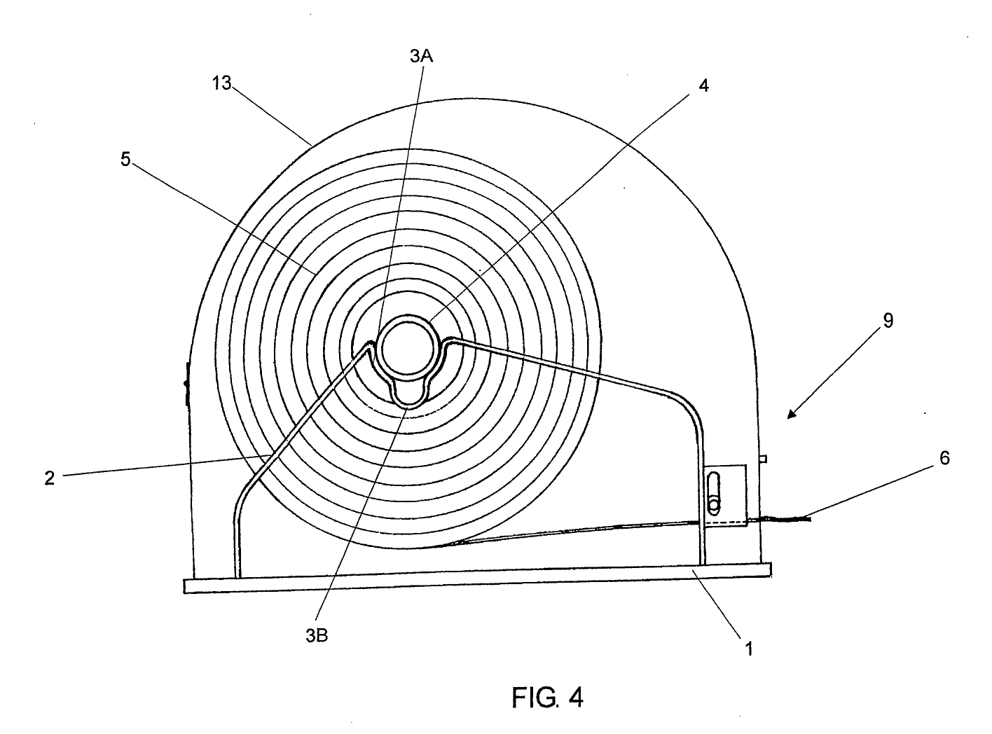

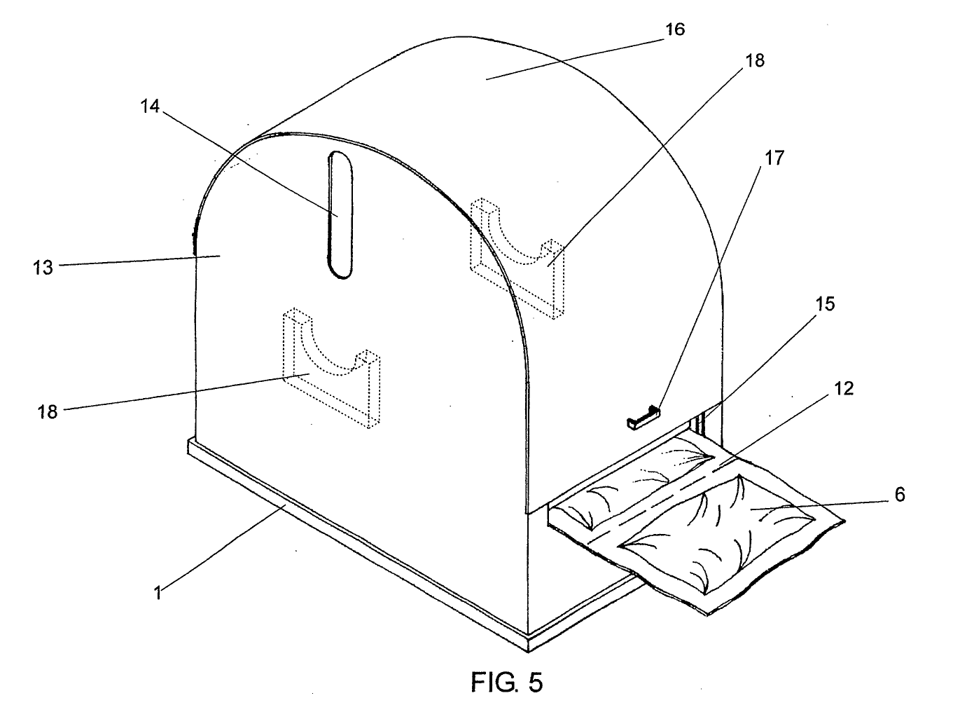

### TECHNICAL SECTOR

Particularly, the present invention refers to a kind of manual dispenser for rolls of aseptic collectors usually used in the bottom of disposable trays, like those noticeably used for packing and selling of meat, fish, cheese and other kinds of food, in bulk or retail stores.

### TECHNICAL STATE

As common knowledge, nowadays there are many kinds, shapes and sizes of trays used for packing and selling of different products like: meat, fish, cheese, sliced cold processed food.

In many commercial centers and butchery shops, whatever of chicken, bull-flesh, pork, fish or other ones, it is usual to prepare them in determined pieces, slices, beefs and other ways that may ease the customer handling, and under these conditions, to make the final product look better, the food is positioned in disposable trays and other packages, and so, in the bottom of each tray a envelope is positioned, normally known as liquid aseptic collectors, absorbent pads, pads, etc, which function is to absorb liquids expelled by the products and in this way the entire package becomes more aseptic, reducing the degradation speed of this liquid and product and, plus, makes the product much more attractive for sale. The environments where these products are handled like butcheries, fisheries, warehouses, supermarkets and others, are many times subjected to diverse environmental infestations like: contaminated dust, hear, saliva, fungus, blood and other adversities of hygiene and sanity.

On the other hand, nowadays there are trays been supplied with the collectors inside. Logically this condition occurs with big companies consuming enormous amounts and not with smaller companies, or under determined conditions when the kind of tray is out of the company most sold products. Thus, it is necessary to use the collector one by one when it is not supplied inside the tray. In this case, nowadays the collectors are supplied essentially inside a package (plastic sack) without order or even in rolls without support, what makes it difficult to handle and use.

### OBJECTIVES OF THE INVENTION

The first objective of the invention is to create better conditions to use the liquid aseptic collectors in rolls, where each unit is attached to the other with just one transversal perforated line.

The second objective of the invention is to male concrete a dispenser support for the collector rolls referred above.

The third objective is to make a frontal exit in the support specially projected to let the aseptic collector be pulled out easily one by one, including resources to position the following collector in a manner to let it be released as easily as the previous one.

The forth objective is to protect the aseptic collectors against environmental adversities cited before, because its elements may get in contact with the food, even indirectly. This protection is vital talking into account how easy diseases may spread in the environment where hygiene is fundamental, but for its nature, it is subjected to all possible kinds of contamination. Thus, this necessary and fundamental technological advance is very important to prevent diseases and maintain the precepts of the public health.

With such characteristics, the present kit becomes ideal to be used in every store, big or small, specially in small stores, where the aseptic collectors can be placed in order, fully protected against negative external agents, and still be pulled out one by one at any moment needed, so that it can be positioned over trays and other packages that will receive the food. It may also be used to prepare the trays previously, where the aseptic collectors are placed and possibly glued in the trays for posterior use.

To better understanding of the support, there is a detailed description of it below, with references to attached drawings, where the:

PICTURE 1 represents a perspective exploded view showing the internal set.

PICTURE 2 shows a perspective view of the support fully mounted.

PICTURE 3 illustrates a lateral cut view showing the roll resting in its axis.

PICTURE 4 is the same view as the anterior one, but standing out the fact that the roll may stay supported and rotate in its own tube.

PICTURE 5 is the same view as PICTURE 2, but, shows that the inside of the cast may have a pair off supports or bearings to let the aseptic collector roll tube rotate.

According to these illustrations and details, the present DISPENSER SUPPORT FOR LIQUID ASEPTIC COLLECTORS is characterized by the fact that, initially, it is a piece of furniture to accommodate aseptic collector rolls, as well as that each collector is detached through its perforated line and for this reason the set is a support base as a rectangular platform (1) over which there are two elements elevated as bearings (2), each of them is made of wire with an inverted U or V shape so that its inferior extremities can be craved in the platform (1), as well as the top of the called “bearings” are equally shaped forming a wide semicircular rest (3a) and another thinner semicircular rest (3b). The first as a rotatory support for the aseptic liquid collector roll (5) tube (4), and the second as a equally rotatory support for an shaft (7), which extremities have circular channels (8) to connect with the sector (3b) and, in this case, the shaft (7) goes freely through the roll (5) tube (4) that unrolls forward passing through the frontal guide (9), formed by a U flatboat bar (10) with a fluctuant counterweight cylinder (11), through which goes the collectors (6) attached to each other with perforated lines (12), and finally the whole set is protected by a cast (13) that not only includes a lateral transparent window (14), but also has an window exit (15) in its anterior part aligned with the fluctuant counterweight (11), and also a inclinable cover (16) with a handle (17) over the window exit (15), through where the device is reloaded.

The cast (13) main objective is to protect the aseptic collectors against environmental negative factors cited above.

Regarding the picture 5, as a construction variation, the internal sidewalls of the cast (13) can still have supports (18), one in each side, becoming bearings to the extremities of the roll (5) tube (4). They are necessary to a continuous use when the device or the bearings (2) is damaged. Thus, the cast can also be used as a support and dispenser.

It is noticeable that after all those explanations and illustrations, the aseptic collectors (6) are prepared in rolls (5), detached in its perforated lines. Thus, the collectors extend and go through a counterweight (11) and the support (10), in a way that with an upward movement, the first collector (6) is pulled out and, at the same time, the following one is positioned, ready to be detached. Thus, this kit can be used with advantages in different stores and industries, whatever small or big, both inside the reserved staff areas and the circulation consumer areas.

1. Dispenser support for liquid aseptic collectors, in the form of a piece of furniture to accommodate aseptic collectors prepared in rolls, as well as each collector is detached through a perforated line, wherein it comprises of a support base as a rectangular platform (1), over which there are two elevated elements working as bearings (2), each of them made of wire ordinarily inverted U or V shaped, so that its inferior extremities can be craved in the platform (1), as well as the top of the called bearings are equally shaped forming a wide semicircular rest (3a) and another thinner semicircular rest (3b). The first as a rotatory support for the aseptic liquid collector roll (5) tube (4), and the second as an equally rotatory support for a shaft (7), which extremities have circular channels (8) to connect with the sector (3b) and, in this case, the shaft (7) goes freely through the roll (5) tube (4) that unrolls forward passing through the frontal guide (9), formed by a U flatboat bar (10) with a fluctuant counterweight cylinder (11), through which goes the collectors (6) attached to each other with perforated lines (12), and finally the whole set is protected by a cast (13) that not only includes a lateral transparent window (14), but also has an window exit (15) in its anterior part aligned with the fluctuant counterweight (11), and also a inclinable cover (16) with a handle (17) over the window exit (15), through where the device is reloaded.

2. Dispenser support for liquid aseptic collectors, according to claim 1, wherein, in a construction variation, the internal sidewalls of the cast (13) include supports (18), one in each side, that constitute support bearings to the extremities of the roll (5) tube (4).
